(19) United States
(12) Patent Application Publication
(10) Pub. No.: US 2011/0154919 A1
(43) Pub. Date: Jun. 30, 2011

(54) Biomedical Assay Device Holder And A Method For Using The Biomedical Assay Device Holder

(75) Inventors: Tsung-Kai Chuang, Tainan County (TW); Chien-Ho Chuang, Kaohsiung (TW); Jiann-hua Wang, Taipei (TW)

(73) Assignee: KAIWOOD Technology Co., Ltd., Tainan County (TW)

(21) Appl. No.: 12/651,157

(22) Filed: Dec. 31, 2009

(51) Int. Cl. B01L 9/00; G01N 21/00

(52) U.S. Cl. 73/864.91

(57) ABSTRACT

The present invention is a biomedical assay device holder and a method for using the biomedical assay device holder. The biomedical assay device holder is used with a biomedical assay device, mounts in an assay device connector assembly and comprises a base and a changeable recess. The base mounts in the assay device connector assembly. The recess is varied to accommodate different biomedical assay devices and is formed in the assay device connector assembly of an opto-electronic assay device to convert a chromatographic or fluorescent result of the biomedical assay device to a numeral result.

### FIELD OF THE INVENTION

The present invention relates to a biomedical assay device holder and a method for using the biomedical assay device holder. The biomedical assay device holder has a changeable recess to accommodate different biomedical assay devices and mounts on an assay device connector assembly of an opto-electronic assay device to convert a chromatographic or fluorescent result of the biomedical assay device to a numeral result.

### BACKGROUND OF THE INVENTION

Medical quality has improved during recent years. The efficiency of determining a biomedical assay result and the precision of a biomedical assay result are important for early diagnosis and treatment of a disease. A conventional biomedical assay requires an excessive amount of time in an incubating stage and requires multiple apparatuses in a detection process to produce chromatographic or fluorescent results that could not be obtained rapidly and accurately.

Progressive development of biomedical assay devices, such as biochips, improves quality of biomedical assay results and simplifies biomedical assay procedures. Using an electronic assay device to convert the chromatographic or fluorescent result of the biochip to a numeral result provides an easy way to understand the assay result. Conventionally, biomedical assay devices may be different shapes, be built to different specifications and require specific devices to analyze the chromatographic or fluorescent result of a specific biomedical assay device.

### SUMMARY OF THE INVENTION

The main objective of the present invention is to provide a biomedical assay device holder and a method for using the biomedical assay device holder. The biomedical assay device holder mounts in a biomedical assay device that mounts on an assay device connector assembly and comprises a base and a changeable recess. The base mounts on the assay device connector assembly. The recess is varied to accommodate different biomedical assay devices and mounts in an assay device connector assembly of an opto-electronic assay device to convert a chromatographic or fluorescent result of the biomedical assay device to a numeral result.

### BRIEF DESCRIPTION OF THE DRAWINGS

FIG. 1 is a perspective view of a first embodiment of an assay device holder in accordance with the present invention.

FIG. 2 is a perspective view of a second embodiment of an assay device holder in accordance with the present invention.

FIG. 3 is a top view of the first embodiment of the assay device holder in FIG. 1.

FIG. 4 is an exploded perspective view of the first embodiment of the assay device holder in FIG. 1 being mounted on an assay device connector assembly.

### DETAILED DESCRIPTION OF THE PRESENT INVENTION

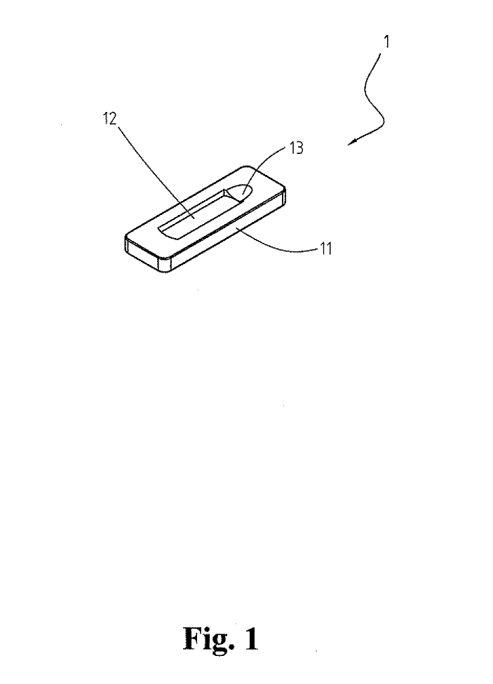

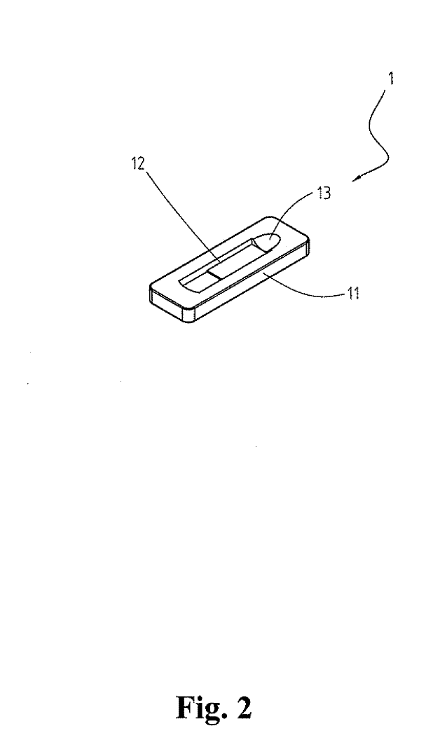

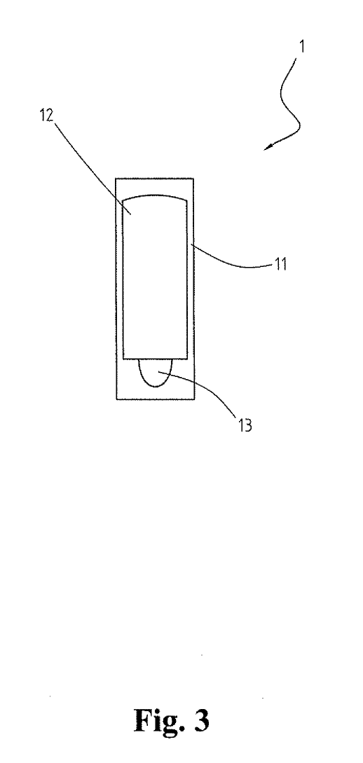

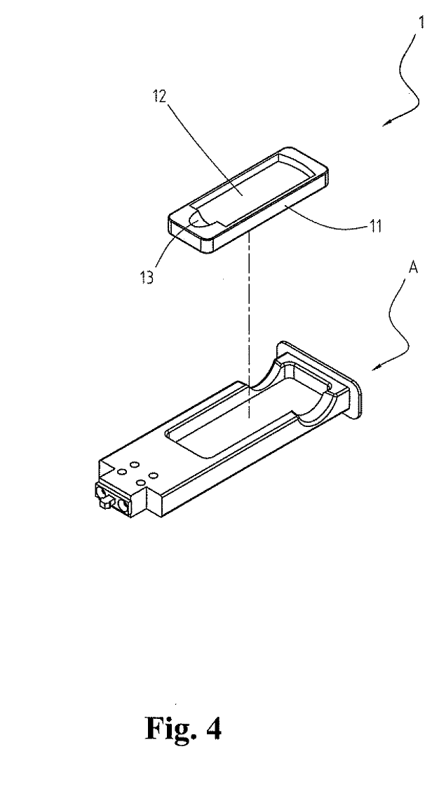

With reference to FIGS. 1 to 4, a biomedical assay device holder (1, 1′) in accordance with the present invention holds a biomedical assay device (not shown), mounts in an assay device connector assembly (A), has a central point and comprises a base (11), a recess (12), an optional removal notch (13), at least one optional recognition feature, multiple optional reference feature and an optional sensor.

A drop of fluid such as blood, urine or saliva is placed on the biomedical assay device and indicates a biomedical assay results by color or fluorescence.

The assay device connector assembly (A) is inserted into an opto-electronic assay device to convert the biomedical assay result to a numeral result.

The base (11) is mounted in the assay device connector assembly (A).

The recesses (12, 12′) is varied to accommodate different biomedical assay devices and mount in the assay device connector assembly (A) of an opto-electronic assay device to convert a chromatographic or fluorescent result of the biomedical assay device to a numeral result and may have a shape selected from a group consisting of circular, rectangular, polygonal or irregular.

The optional removal notch (13) is formed on the base (11) and communicates with the recess (12, 12′).

The optional recognition feature may be formed on the base (11) and be used to differentiate different biomedical assay devices.

The optional reference feature may be formed on the base (11) around the recess (12, 12′) so the opto-electronic assay device will recognize the applicable biomedical assay device specification.

The optional sensor may be mounted inside the base (11), be used to identify an assay device specification of the opto-electronic assay device and may be a radio frequency identification (RFID) device.

A method for using the biomedical assay device comprises steps of (a) preparing a sample, (b) positioning the biomedical assay device holder and (c) reading biomedical assay results of the biomedical assay device.

Step (a) of preparing a sample comprises dropping a biomedical fluid onto a biomedical assay device, placing the biomedical assay device in a biomedical assay device holder and placing the biomedical assay device holder in an assay device connector assembly.

Step (b) of positioning the biomedical assay device holder comprises inserting the assay device assembly into an opto-electronic assay device, identifying and positioning the biomedical assay device using a central point of the biomedical assay device, and optionally step (b1) calibrating the biomedical assay device holder position by multiple optional reference features, at least one recognition feature or a sensor.

Step (c) of reading biomedical assay results of the biomedical assay device comprises converting the biomedical assay results to numeral results.

The method in accordance with the present invention further optionally comprises a step (d) of calculating comprising converting signals of the biomedical assay device to a numeral result. Step (d) may further optionally comprise a step (d1) of generating a calibration curve by a serial concentration of a standard solution.

What is claimed is:

1. A biomedical assay device holder holding a biomedical assay device, mounting on an assay device connector assembly, having a central point and comprising
a base being mounted on the assay device connector assembly; and
a recess being varied to accommodate different biomedical assay devices and mounting in the assay device connector assembly of an opto-electronic assay device to convert a chromatographic or fluorescent result of the biomedical assay device to a numeral result.

2. The biomedical assay device holder as claimed in claim 1, wherein the recess in the biomedical assay device holder has a shape selected from a group consisting of circular, rectangular, polygonal and irregular.

3. The biomedical assay device holder as claimed in claim 2, wherein the assay device holder further comprises
a removal notch formed on the base and communicating with the recess.

4. The biomedical assay device holder as claimed in claim 3, wherein the assay device holder further comprises
at least one recognition feature being formed on the base to differentiate different biomedical assay devices.

5. The biomedical assay device holder as claimed in claim 3, wherein the assay device holder further comprises
multiple reference features being formed on the base around the recess so the opto-electronic assay device will identify a biomedical assay device specification.

6. The biomedical assay device holder as claimed in claim 2, wherein the assay device holder further comprises
a sensor mounted inside the base so the opto-electronic assay device will identify an assay device specification.

7. The biomedical assay device holder as claimed in claim 6, wherein the sensor is a radio frequency identification (RFID) device.

8. A method for using the biomedical assay device holder having a base mounted on the assay device connector assembly and a recess being varied to accommodating different biomedical assay devices and mounting in the assay device connector assembly of an opto-electronic assay device to convert a chromatographic or fluorescent result of the biomedical assay device to a numeral result, the method comprising steps of
(a) preparing a sample comprising dropping a biomedical fluid onto a biomedical assay device, placing the biomedical assay device in a biomedical assay device holder and placing the biomedical assay device holder in an assay device connector assembly;
(b) positioning the biomedical assay device holder comprising inserting the assay device assembly into the opto-electronic assay device and identifying and positioning the biomedical assay device using a central point of the biomedical assay device; and
(c) reading biomedical assay results of the biomedical assay device comprising converting the biomedical assay results to numeral results.

9. The method as claimed in claim 8 wherein step (b) further comprises step (b1) of calibrating the biomedical assay device holder position.

10. The method as claimed in claim 9, wherein the biomedical assay device holder position is calibrated by multiple reference features.

11. The method as claimed in claim 9, wherein the biomedical assay device holder position is calibrated by at least one recognition feature.

12. The method as claimed in claim 9, wherein the biomedical assay device holder position is calibrated by a sensor.

13. The method as claimed in claim 8 further comprising step (d) of calculating comprising converting signals of the biomedical assay device to a numeral results.

14. The method as claimed in claim 13, wherein step (d) further comprises a step (d1) of generating a calibration curve by a serial concentration of a standard solution.
